(19) United States
(12) Patent Application Publication
(10) Pub. No.: US 2018/0133798 A1
(43) Pub. Date: May 17, 2018

(54) SYSTEM FOR ADDITIVE MANUFACTURING OF THREE-DIMENSIONAL OBJECTS

(71) Applicant: CL SCHUTZRECHTSVERWALTUNGS GMBH, Lichtenfels (DE)

(72) Inventors: Jens STAMMBERGER, Rodental (DE); Alexander Hofmann, Weismain (DE)

(73) Assignee: CL SCHUTZRECHTSVERWALTUNGS GMBH, Lichtenfels (DE)

(21) Appl. No.: 15/812,976

(22) Filed: Nov. 14, 2017

(30) Foreign Application Priority Data
Nov. 14, 2016 (DE) 102016121778.6

(51) Int. Cl. B22F 3/105; B29C 64/153; B29C 64/255; B29C 64/35; B33Y 30/00; B28B 1/00

(52) U.S. Cl. CPC B22F 3/1055; B29C 64/153; B29C 64/255; B22F 2003/1059; B33Y 30/00; B28B 1/001; B22F 2003/1056; B29C 64/35

(57) ABSTRACT

A system for additive manufacturing of three-dimensional objects, comprising one or more working stations provided for performing at least one working process in additive manufacturing of three-dimensional objects, and a transport device provided for transporting powder modules used in additive manufacturing of three-dimensional objects within a working station and/or between several working stations, wherein the transport device comprises several transport units, wherein a respective transport unit comprises a carrying device comprising a carrying structure, which is provided for carrying at least one powder module arranged in the carrying structure, a first drive device provided for generating a movement of a powder module arranged in the carrying structure of the carrying device relative to the carrying device along an, especially linear, first movement axis, and a second drive device provided for generating a rotational movement of the carrying structure together with a powder module.

The invention relates to a system for additive manufacturing of three-dimensional objects, comprising one or more working stations each provided for performing at least one working process in additive manufacturing of three-dimensional objects, and a transport device provided for transporting powder modules used in additive manufacturing of three-dimensional objects within a working station and/or between several working stations.

Systems for additive manufacturing of three-dimensional objects are basically known. Respective systems typically comprise several working stations, each of which is provided for performing at least one working process in the additive manufacturing of three-dimensional objects. Respective systems can comprise a transport device provided for transporting powder modules used in additive manufacturing of three-dimensional objects within a working station and/or between several working stations.

Respective transport devices are to date provided such that they enable transport of a powder module, i.e., for example, a construction module, in which the actual additive construction of three-dimensional objects is carried out, only along a (linear) movement axis. For certain concepts of respective systems, the movement of corresponding powder modules only along one (linear) movement axis might not be sufficient.

The invention is based on the object of providing, especially in terms of the possibility of movement of a powder module in several freedom degrees of motion, an improved apparatus for additive manufacturing of three-dimensional objects.

The object is solved by a system according to claim 1. The dependent claims relate to possible embodiments of the system.

The system herein described (“system”) serves the additive manufacturing of three-dimensional objects, i.e., for example, technical components or technical component groups. The system comprises one or more working stations each provided for performing at least one working process in the additive manufacturing of three-dimensional objects (“objects”). Respective working processes in the additive manufacturing of an object on the one hand relate to additive working processes, i.e. additive construction processes, in which additive construction of an object is actually carried out, especially by successive, selective layer-by-layer exposure and thus successive, selective layer-by-layer solidification of construction material layers of a construction material that can be solidified by means of an energy beam, and preparatory working processes to be performed or performed prior to an additive working process, i.e. especially prior to a construction process, i.e. for example cleaning, inerting, and temperature control processes of powder modules, and post-processing working processes to be performed or performed after an additive working process, i.e. especially after a construction process, i.e., for example, unpacking processes of objects additively manufactured from respective powder modules.

A first working station provided for performing additive working processes, also referred to as process station can thus comprise an apparatus (“apparatus”) for additive manufacturing of objects. The apparatus is provided for additive manufacturing of objects, i.e., for example, technical components or technical component groups, by successive, selective layer-by-layer exposure and thus successive, selective layer-by-layer solidification of construction material layers of a construction material that can be solidified. The construction material can be a particulate or powdered metal material, plastic material, and/or ceramic material. The selective solidification of respective construction material layers to be selectively solidified is carried out based on object-related construction data. Respective construction data describe the geometric structural design of the respective object to be additively manufactured and can, for example, include “sliced” CAD data of the object to be additively manufactured. The apparatus can be formed as an SLM apparatus, i.e. as an apparatus for performing selective laser melting methods (SLM methods), or as an SLS apparatus, i.e. as an apparatus for performing selective laser sintering methods (SLS methods).

The apparatus comprises the functional components typically required for performing additive construction processes. This especially involves a coating device provided for forming construction material layers (in the construction plane of the apparatus) to be selectively solidified, and an exposure device provided for the selective exposure of construction material layers (in the construction plane of the apparatus) to be selectively solidified. The coating device typically comprises several components, i.e., for example, a coating element comprising an, especially blade-shaped, coating tool, and a guiding device for guiding the coating element along a defined trajectory. The exposure device typically also comprises several components, i.e., for example, a beam generation device for generating an energy or laser beam, a beam deflection device (scanner device) for deflecting an energy or laser beam generated by the beam generation device to a section to be exposed, of a construction material layer to be selectively solidified and to various optical elements, such as lens elements, objective elements, etc. The functional components of the apparatus mentioned are typically arranged or formed on or in a, typically inertable, process chamber of the apparatus.

An optional other (or second) working station provided for performing post-processing working processes, also referred to as post-processing station, can comprise an apparatus for unpacking an object additively manufactured. The apparatus can be provided for unpacking an object additively manufactured by removing the, typically non-solidified, construction material surrounding the object additively manufactured. The apparatus here comprises the functional components required for removing the, typically non-solidified, construction material surrounding the object additively manufactured. This especially involves a suction and/or blower device provided for generating a suction and/or blower flow by means of which the construction material to be removed can be suctioned or blown off.

An optional other (or third) working station provided for performing preparatory working processes, also referred to as preparatory station, can comprise an apparatus for cleaning and/or inerting and/or temperature controlling powder modules. The apparatus can be provided for cleaning and/or inerting and/or temperature controlling powder modules. The apparatus here comprises the functional components required for cleaning and/or inerting and/or temperature controlling of powder modules. This especially involves a cleaning device, which is e.g. provided for generating a cleaning flow cleaning a powder chamber of the powder module, or an inerting device, which is provided for generating an inert gas flow inerting a powder chamber of the powder module, or a temperature control device, which is provided for temperature controlling a powder module to a certain target temperature.

Independent of their specific functional designs, respective working stations typically comprise an own housing or frame construction, on or in which the functional components of the respective working station are arranged or formed. The working stations are thus to be seen as separate functional units of the system, spatially-physically defined by respective housing or frame constructions, which can be positioned in various configurations relative to each other, e.g. in one or more housing (portions), especially factory buildings.

The system typically comprises a plurality of powder modules used in the additive manufacturing of three-dimensional objects. A respective powder module is provided for receiving and/or dispensing construction material and, for this purpose, typically comprises a powder chamber. The powder chamber limits a powder room that can be filled with construction material. The powder room is limited at least on the side by walls (powder chamber walls) of the powder chamber generally formed like a hollow parallelepiped or a hollow cylinder. At the bottom, the powder room is limited by a carrying device. The carrying device is typically movably supported between two end positions, i.e. between an upper end position (relative to the height of the powder module) and a lower end position, relative to the powder chamber. The movable support of the carrying device enables the realization of an, especially linear, movement of the carrying device along a vertical movement axis or in a vertical movement direction. The movable support of the carrying device is typically realized by an, especially (electric) motor, drive and/or actuator device coupled with the carrying device.

Specifically, the powder module can be a construction module, in which the actual additive construction of objects is performed and which, for this purpose, is filled with construction material to be solidified in a successive, selective layer-by-layer manner when performing additive construction processes, or a metering module, via which, when performing additive construction processes, construction material is metered out into the process chamber, or a collector module and overflow module, respectively, which, when performing additive construction processes, is filled with non-solidified construction material.

Further, the system comprises a transport device. The transport device is provided for transporting powder modules within a working station or, if the system comprises several working stations, for transporting powder modules between different working stations of the system. By means of the transport device, transport axes or tracks are defined, along which powder modules can be moved within working stations and/or between working stations.

The transport device comprises several transport units. The transport units are typically integrated in working stations or in a tunnel structure that is explained further below, extending between several working stations. The transport units as such cannot be (linearly) moved.

A respective transport unit comprises a carrying device comprising a carrying structure, provided for carrying a powder module arranged in the carrying structure, i.e., moved into the carrying structure. As it follows from below, respective powder modules arranged in a carrying structure are typically movably supported relative to the carrying structure. The carrying structure can comprise several carrying structure elements. The carrying structure, i.e. especially respective carrying structure elements, can be equipped with storage elements enabling movable storage of a powder module arranged in the carrying structure. Respective storage elements can be sliding or roller storage elements, which engage in reception-like guidings (not denoted in more detail) of a powder module, intended for this purpose. A specific embodiment of a respective carrying structure can comprise an (essentially) U-shaped geometric-structural design with two leg-like secondary carrying structure elements (rect)angularly projecting from a leg-like primary carrying structure element. Respective storage elements are arranged or formed on the surfaces of the secondary carrying structure elements opposite each other.

A respective transport unit further comprises a first drive device and a separate second drive device. The first drive device is provided for generating movement, especially a linear movement, of a powder module arranged in the carrying structure, relative to the carrying structure along an, especially linear, first movement axis. Thus, by means of the first drive device a first drive force can be generated, moving a powder module arranged in the carrying structure relative to the carrying structure. The second drive device is provided for generating a rotational movement of the carrying structure, possibly in addition to a powder module arranged therein, around a second movement axis (rotational axis), especially around a vertical rotational axis. Thus, by means of the second drive device a second drive force can be generated (rotationally) moving a carrying structure, possibly in addition to a powder module arranged therein. A rotation of the carrying structure around the second movement axis similarly causes a rotation of the first movement axis. Consequently, by rotating the carrying structure, the first movement axis can be brought into a certain orientation, especially relative to a first movement axis of a further transport unit arranged directly adjacent the respective transport unit.

Overall, the carrying device or a respective transport unit associated with that enables movement of a powder module in two different freedom degrees of motion. A first freedom degree of motion is given by the movement of a powder module relative to the carrying structure along the first movement axis, which can be realized by means of the first drive device; a second freedom degree of motion is given by the rotational movement of a carrying structure in addition to a powder module arranged therein around the second movement axis, which can be realized by means of the second drive device. Thus, especially in terms of the possibility of movement of a powder module in several freedom degrees of motion, an improved system for additive manufacturing of three-dimensional objects is provided.

The first drive device can comprise at least a first drive unit and a power transmission unit coupled with the first drive unit. The first drive unit is provided for generating the first drive force setting a powder module in motion along a first movement axis. The first drive unit can be formed as or comprise a linear drive. A respective linear drive can be formed as or comprise a hydraulic or pneumatic drive cylinder, threaded drive, especially a ball screw drive or roller screw drive, or a spindle drive.

The power transmission unit is provided for transmitting the first drive force generated by the drive unit to the powder module. The power transmission unit can comprise at least one power transmission element coupled with the first drive unit. The power transmission element is coupled with the first drive unit such that in generating the first drive force setting a powder module in motion along the first movement axis, it can be moved along the first movement axis.

The power transmission element can be movably supported between an operating position, in which the power transmission element can be coupled or is coupled with a powder module for transmitting the first drive force to the powder module, and a non-operating position, in which the power transmission element cannot be coupled or is not coupled with a powder module for transmitting the first drive force to the powder module. The operating position typically corresponds to a position of the power transmission element extended (from a housing receiving the power transmission element); the non-operating position typically corresponds to a position of the power transmission element retracted (into the housing receiving the power transmission element). The movement of the power transmission element between the operating and the non-operating positions is carried out via a drive unit associated with the power transmission unit, which is provided for generating an, especially linear, movement of the power transmission element into the operating position and into the non-operating position. The drive unit can, analogous to the first drive unit, be formed as or comprise a linear drive.

The power transmission element can be formed as an, especially projection-like or projection-shaped, form-locked element. In the operating position (extended position), the form-locked element can be coupled or is coupled in a form-locked manner with a powder module for transmitting the first drive force to the powder module by the form-locked element interacting with a counter form-locked element on the powder module in a form-locked manner, i.e., for example, engaging a corresponding, especially reception-like or reception-shaped, counter form-locked element on the powder module. In the non-operating position (retracted position), the form-locked element cannot be coupled or is not coupled in a form-locked manner with the powder module for transmitting the first drive force to the powder module by the form-locked element not interacting with a counter form-locked element on the powder module in a form-locked manner, i.e., for example, not engaging a corresponding, especially reception-like, counter form-locked element on the powder module. Of course, principally, a configuration of respective form-locked elements and counter form-locked elements is also possible, whereby the counter form-lock element is formed especially projection-like or projection-shaped and the form-locked element is formed in a reception-like or reception-shaped manner.

The second drive device can comprise at least one second drive unit. The second drive unit is provided for generating the second drive force setting a carrying structure in rotary motion around the second movement axis. The second drive unit can be formed as or comprise a rotary drive. The rotary drive can form the second movement axis or can be (directly) integrated in the second movement axis. The rotary drive can, e.g., be integrated in a storage device storing the carrying structure on the working station. The second drive unit can, however, be formed as or comprise a linear drive. A respective linear drive can, in turn, be formed as a hydraulic or pneumatic drive cylinder, threaded drive, especially a ball screw drive or roller screw drive, or a spindle drive or comprise one of the drives mentioned.

It is possible that the second drive device comprises two second drive units, wherein a first second drive unit is provided for generating a second drive force setting the carrying structure in rotary motion in a first rotational direction, e.g. clockwise, around the second movement axis, and a second second drive unit for generating a second drive force setting the carrying structure in rotary motion in a second rotational direction, e.g. counter-clockwise, around the second movement axis.

Especially in the case, in which a second drive unit is formed as or comprises a linear drive, the second drive device can comprise a power transmission unit coupled with the second drive unit, which is provided for transmitting the second drive force generated by the second drive unit to the carrying structure. The power transmission unit can comprise at least one power transmission element, especially a thrust or tensile element, coupled with the carrying structure for transmitting thrust or tensile forces, i.e., for example, a cable pull. A respective power transmission element is typically eccentrically attached to the carrying structure via an attachment point assigned to the carrying structure.

It was mentioned that the transport device can be provided for transporting powder modules within a working station. A working station can comprise a, typically elongated, transport track extending through the working station, especially forming part of a transport axis of the system, and at least one powder module-specific powder module working position communicating with the transport track. A powder module-specific powder module working position is a position of a powder module, in which a respective powder module is arranged in the respective working station for an operation in its intended use. The transport device is here provided for moving or transporting a powder module along the transport track extending through the working station and/or for moving or transporting a powder module from the transport track into the at least one powder module working position and/or for transporting a powder module from the at least one powder module working position into the transport track. The powder module working positions typically extend along the transport track or are arranged in parallel to that.

For example, a working station in the form of a process station can comprise a transport track extending therethrough and powder module working positions, especially adjacently arranged and communicating with the transport track, for a metering module, a construction module, and an overflow module. The powder module working positions are typically arranged connected in series in the order mentioned.

Since the powder module working positions are typically arranged (rect)angularly relative to the transport track, for the purpose of transportation or movement of a powder module from a powder module working position into the transport track or vice versa, a rotation of the powder module around the second movement axis and a movement of the powder module along the first movement axis are typically necessary.

The transport track is, as mentioned, typically elongated. The transport track is therefore typically formed by several transport units arranged or formed connected in series. In contrast, a powder module working position is typically formed by only one (single) transport unit. In all cases, the transport units of the transport device can be arranged or are arranged such that a powder module can be transferred from a first transport unit to one other transport unit that is arranged directly adjacent to that; consequently, a powder module can be moved or transferred from a first transport unit to one transport unit arranged directly adjacent to that.

For transferring a powder module from a first transport unit to another transport unit that is arranged directly adjacent to that, an equal orientation of the first movement axis of the transport units is required. Transferring a powder module from a first transport unit to one other transport unit that is arranged directly adjacent to that, is thus connected with a movement of the powder module along the respective first movement axis. Depending on the spatial orientation of the respective first movement axes of the transport units relative to each other, a rotation of the carrying structure around the second movement axis can (additionally) be required for transferring a powder module from a first transport unit to one other transport unit arranged directly adjacent to that. The rotation of the carrying structure serves for equally orientating the respective first movement axes of the transport units. A rotational position, in which the carrying structure of a first transport unit is oriented such that the first movement axis of the first transport unit equals the first movement axis of another transport unit arranged directly adjacent to that, can be referred to as transfer position of the transport unit.

It has been mentioned that the transport device can also be provided for transporting powder modules between at least two working stations. The two working stations can be arranged directly adjacent. A first working station and another working station directly adjacently arranged can each comprise a transport track extending through the first working station. The transport track of the first working station and the transport track of the other working station are arranged or formed aligned with each other and typically blend into each other such that a powder module can be moved or transferred from the transport track of the first working station to the transport track of the other working station, or vice versa. The transport device is here provided for transporting a powder module along the transport track extending through the respective working station and/or for transporting a powder module from the transport track of a working station into a powder module working position of the working station and/or for transporting a powder module from a powder module working position of a working station into the transport track of the working station.

The transport device can also be provided for transporting powder modules between at least two working stations arranged spatially spaced apart, wherein a first working station comprises a transport track extending through the first working station, and another working station directly adjacently arranged comprises a transport track extending through the other working station, and a tunnel structure extending between the first working station and the at least one other working station comprises a transport track extending through the tunnel structure. The transport track of the first working station and the transport track of the tunnel structure as well as the transport track of the second working station and the transport track of the tunnel structure are each arranged or formed aligned with each other and typically blend into each other such that a powder module can be moved or transferred from the transport track of the first working station to the transport track of the tunnel structure, or vice versa, and a powder module can be transferred from the transport track of the second working station to the transport track of the tunnel structure, or vice versa.

The system can thus comprise a tunnel structure. The tunnel structure has one or more tunnel sections, in which or through which at least one powder module can be moved. In a respective tunnel section, at least one transport unit is formed or arranged, and thus a transport track defined by transport unit(s) arranged therein, along which a powder module can be moved through the tunnel section. It is possible to at least partially form or arrange several transport tracks in a tunnel section, i.e., for example, transport tracks adjacently arranged, especially in parallel, in one or more planes. The transport tracks formed in respective working stations can also be considered as tunnel sections.

The function of the tunnel structure or the tunnel sections associated with that is to connect at least two different working stations of the system directly or indirectly with each other, i.e., for example, by interconnecting at least one other tunnel section and/or another working station of the system. The connection of respective working stations enables moving respective powder modules between different working stations of the system. By one or more tunnel sections, a process station associated with the system can be connected with a post-processing station associated with the system. Movement of respective powder modules through the tunnel structure is especially possible in a fully-automated way.

Depending on the specific design of the tunnel structure, it can be possible that the transport track along which a powder module is moved back, starting from a first working station of the system, into another working station of the system is different from the transport track along which the powder module was moved starting from the first working station into the other working station. The selection of a transport track of a powder module can be carried out between respective working stations based on certain prioritizations of certain powder modules. For powder modules of higher priority, shorter distance or faster transport tracks than for powder modules of lower priority can be selected. Similarly, powder modules of higher priority can be moved with a higher speed compared to powder modules of lower priority.

The control of all movements of the powder modules moved in the system, especially in the tunnel structure, is carried out via a central control device, which purposefully, e.g. radio-based, communicates directly or indirectly with respective powder modules, which for this purpose are equipped with suitable communication devices. In the control device, all information relevant for the movement of respective powder modules within the system or the tunnel structure, i.e. especially respective movement information, i.e., for example, speed information, respective position information, i.e., for example, start and finish information, respective prioritization information, etc., are purposefully provided. The movements of the powder modules in the system or tunnel structure can be controlled in a fully automated way.

As mentioned, the tunnel structure comprises one or more tunnel sections. A respective tunnel section limits at least one cavity, in which respective transport units for transporting powder modules are arranged. For the rest, the geometric structural design of a respective tunnel section is freely selectable, with the proviso that at least one powder module can be moved in or through it. A respective tunnel section can have, for example, a round, roundish, or square cross-sectional area. With regard to its length, a respective tunnel section can be formed at least sectionally, especially completely, straight or at least sectionally, especially completely, bent or curved. Of course, a respective tunnel section can be formed of several tunnel section segments, which are or can be connected with each other by forming the respective tunnel section.

A respective tunnel section can end in at least one other tunnel section, e.g. angled to the respective tunnel section. The tunnel structure can, due to a respective arrangement of tunnel sections with transport units arranged therein—similar to a rail or track system known from railroad traffic—, comprise several tunnel sections opening out into each other at defined positions. Several tunnel sections can at least partially be next, above, or below each other. The tunnel structure can thus comprise several tunnel sections which run at least partially next, above, or below each other, and consequently in different (horizontal and/or vertical) planes.

A respective tunnel section can be inertable, i.e., in this section an inert atmosphere can be formed and maintained. Analogously, in a respective tunnel section, a certain pressure level, i.e., for example, an excess pressure or low pressure, can be formed and maintained.

In order to be able to be connected with the tunnel structure, single, several, or all stationary working stations of the system can have a connection or transfer portion, by which they can be connected or are connected with the tunnel structure. In transferring from a working station into the tunnel structure, or vice versa, a powder module is thus to be moved through a respective connecting portion.

The invention is explained in more detail by means of exemplary embodiments in the figures of the drawings. In which:

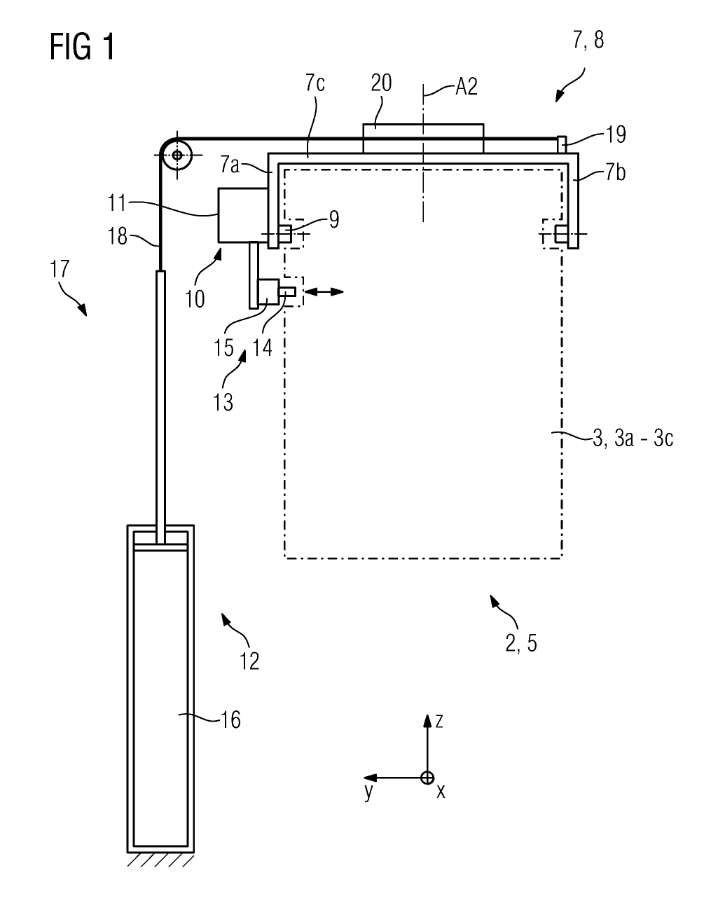

FIG. 1 shows a schematic diagram of a transport unit of a transport device of a system for additive manufacturing of three-dimensional objects according to an exemplary embodiment;

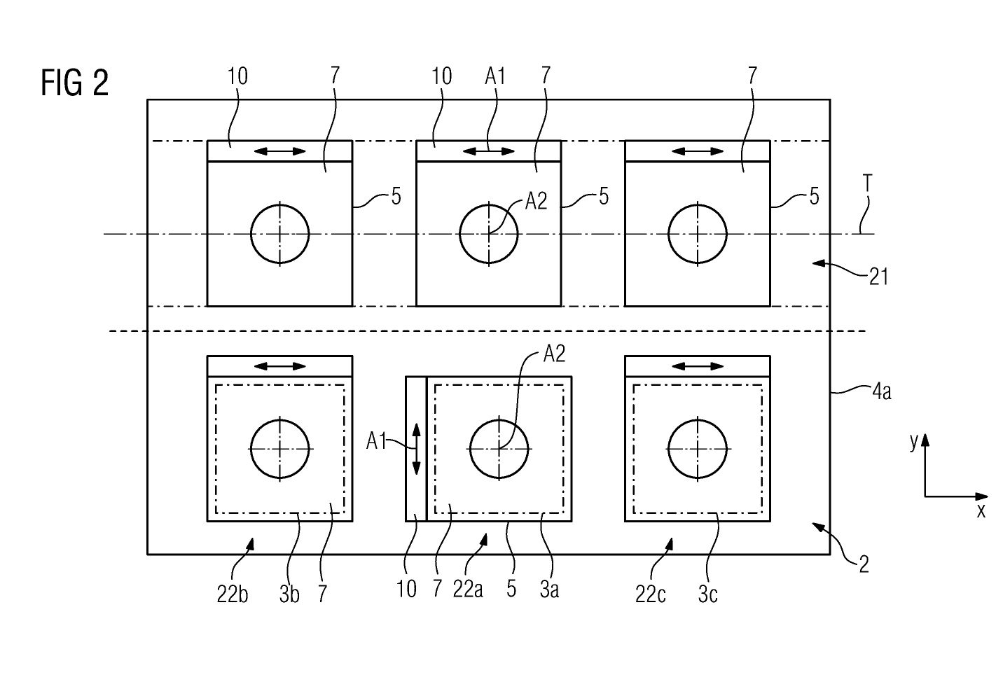

FIG. 2 shows a schematic diagram of a transport device of a system for additive manufacturing of three-dimensional objects according to an exemplary embodiment; and

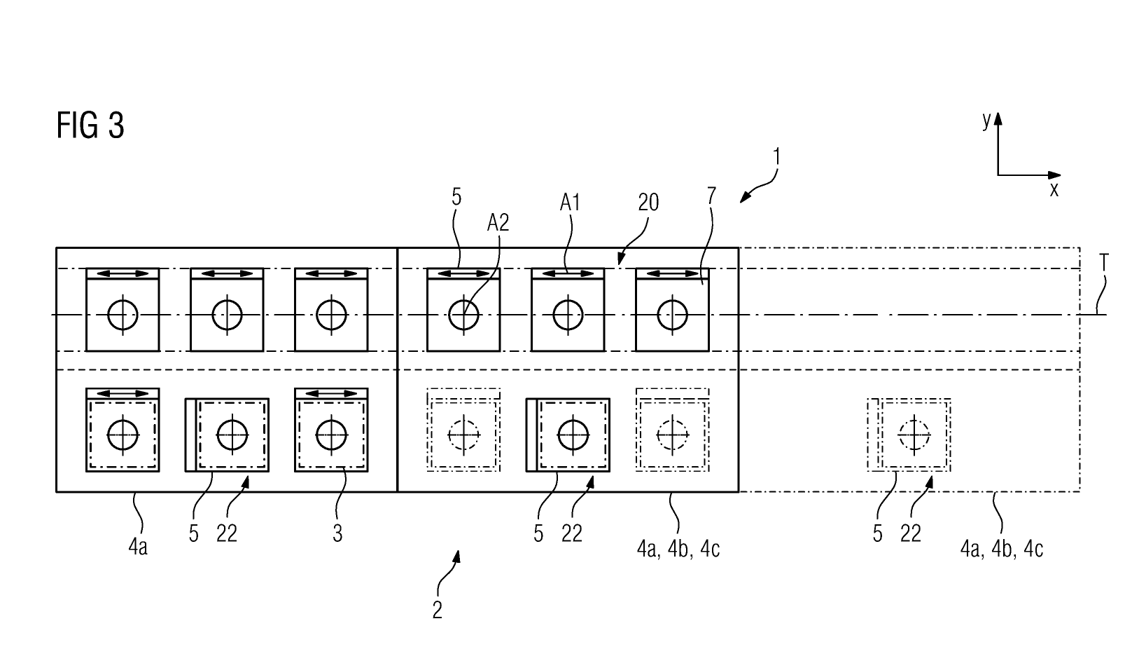

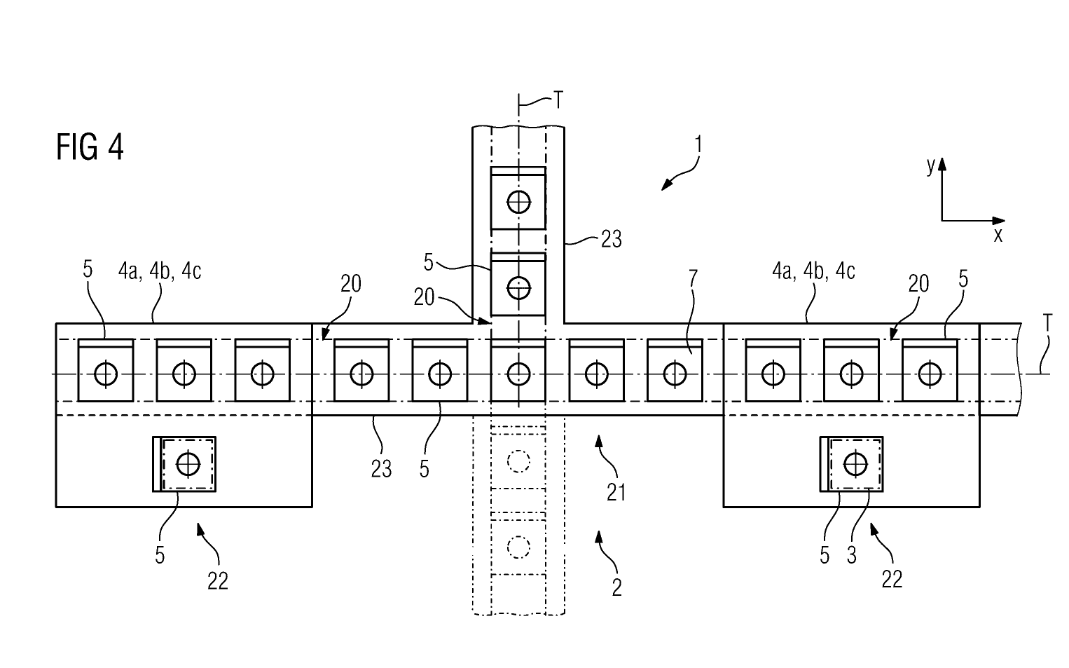

FIGS. 3, 4 each show a schematic diagram of a transport device of a system for additive manufacturing of three-dimensional objects according to an exemplary embodiment.

FIG. 1 shows a schematic diagram of a transport unit 5 of a transport device 2 of a system 1 for additive manufacturing of three-dimensional objects according to an exemplary embodiment. The transport unit 5 shown in FIG. 1 is shown in a front view.

FIG. 2 shows a schematic diagram of a transport device 2 of a system 1 for additive manufacturing of three-dimensional objects according to an exemplary embodiment. The transport device 2 shown in FIG. 2 is shown in a top view.

FIGS. 3, 4 each show a schematic diagram of a system 1 for additive manufacturing of three-dimensional objects according to an exemplary embodiment. The systems 1 shown in FIGS. 3, 4 are shown in a top view.

The system 1 serves the additive manufacturing of three-dimensional objects, i.e. for example technical components or technical component groups. The system 1 comprises several working stations 4, 4a-4c, each provided for performing at least one working process in the additive manufacturing of three-dimensional objects. Respective working processes on the one hand relate to additive working processes, i.e. additive construction processes, in which an additive construction of an object is actually carried out, preparatory working processes to be performed or performed prior to an additive working or construction process, and post-processing working processes to be performed or performed after an additive working or construction process.

A first working station 4a provided for performing additive working processes, also referred to as process station, can thus comprise an apparatus (not shown) for additive manufacturing of objects. The apparatus is provided for additive manufacturing of objects by successive, selective layer-by-layer exposure and thus successive, selective layer-by-layer solidification of construction material layers of a construction material that can be solidified. The construction material can be a particulate or powdered metal material, plastic material, and/or ceramic material. The selective solidification of respective construction material layers to be selectively solidified is carried out based on object-related construction data. Respective construction data describe the geometric structural design of the respective object to be additively manufactured and can, for example, include “sliced” CAD data of the object to be additively manufactured. The apparatus can be formed as an SLM apparatus, i.e. as an apparatus for performing selective laser melting methods (SLM methods), or as an SLS apparatus, i.e. as an apparatus for performing selective laser sintering methods (SLS methods). The apparatus comprises the functional components (not shown) required for performing additive construction processes. This especially involves a coating device provided for forming construction material layers to be selectively solidified, and an exposure device provided for the selective exposure of construction material layers to be selectively solidified. The functional components of the apparatus mentioned are typically arranged or formed on or in an inertable process chamber of the apparatus.

An optional other (or second) working station 4b provided for performing post-processing working processes, also referred to as post-processing station, can comprise an apparatus (not shown) for unpacking an object additively manufactured. The apparatus can be provided for unpacking an object additively manufactured by removing the, typically non-solidified, construction material surrounding the object additively manufactured.

An optional other (or third) working station 4c provided for performing preparatory working processes, also referred to as preparatory station, can comprise an apparatus (not shown) for cleaning and/or inerting and/or temperature controlling powder modules 3, 3a-3c. The apparatus can be provided for cleaning and/or inerting and/or temperature controlling powder modules.

Independent of their specific functional designs, respective working stations 4, 4a-4c comprise their own housing or frame construction (not denoted in more detail), on or in which the functional components of the respective working stations 4, 4a-4c are arranged or formed. The working stations 4, 4a-4c are to be seen as separate functional units of the system 1, spatially-physically defined by respective housing or frame constructions, which, as can be seen from FIGS. 3, 4, can be positioned in various configurations relative to each other, e.g. in one or more housing (portions), especially factory buildings.

The system 1 comprises a plurality of powder modules 3, 3a-3c used in the additive manufacturing of three-dimensional objects. A respective powder module 3, 3a-3c is provided for receiving and/or dispensing construction material and, for this purpose, typically comprises a powder chamber (not shown). The powder chamber limits a powder room that can be filled with construction material. The powder room is limited at least on the side by walls (powder chamber walls) of the powder chamber generally formed like a hollow parallelepiped or a hollow cylinder. At the bottom, the powder room is limited by a carrying device (not shown). The carrying device is typically movably supported between two end positions, i.e. between an upper end position (relative to the height of the powder module 3) and a lower end position, relative to the powder chamber. The movable support of the carrying device enables the realization of an, especially linear, movement of the carrying device along a vertical movement axis or in a vertical movement direction. The movable support of the carrying device is typically realized by an, especially (electric) motor, drive and/or actuator device (not shown) coupled with the carrying device.

A powder module 3 can e.g. be a construction module 3a, in which the actual additive construction of objects is carried out and which, for this purpose, is filled with construction material to be solidified in a successive, selective layer-by-layer manner when performing additive construction processes, or a metering module 3b, via which, when performing additive construction processes, construction material is metered out into the process chamber, or a collector module and overflow module 3c, respectively, which, when performing additive construction processes, is filled with non-solidified construction material.

The transport device 2 is provided for transporting powder modules 3, 3a-3c within in a working station 4, 4a-4c or, if the system 1 comprises several working stations 4, 4a-4c, for transporting powder modules 3, 3a-3c between different working stations 4, 4a-4c of the system 1. By means of the transport device 2, transport axes or tracks are defined, along which powder modules 3, 3a-3c within working stations 4, 4a-4c and/or between working stations 4, 4a-4c can be moved.

From FIG. 2 it can be seen that the transport device 2 comprises several transport units 5. The transport units 5 are integrated in working stations 4, 4a-4c or in a tunnel structure 6 extending between several working stations, which is explained further below. The transport units 5 as such cannot be (linearly) moved.

From FIG. 1 it can be seen that a transport unit 5 comprises a carrying device 8 comprising a carrying structure 7 provided for carrying a powder module 3 arranged in the carrying structure 7, i.e. moved into the carrying structure 7. The carrying structure 7 comprises several carrying structure elements 7a-7c. The carrying structure elements 7a, 7b are equipped with storage elements 9 enabling a movable storage of a powder module 3 arranged in the carrying structure 7. Respective storage elements 9 can be sliding or roller storage elements, which engage in reception-like guidings (not denoted in more detail) in the powder module 3. A specific embodiment of a carrying structure 7, as shown in FIG. 1, has an (essentially) U-shaped geometric-structural design with two leg-like secondary carrying structure elements 7a, 7b (rect)angularly projecting from a primary carrying structure element 7c. The storage elements 9 are arranged on the surfaces of the secondary carrying structure elements 7a, 7b opposite each other.

The transport unit 5 further comprises a first drive device 10 and a separate second drive device 12. The first drive device 10 is provided for generating a linear movement of a powder module 3 arranged in the carrying structure 7 relative to the carrying device 7 along a linear, first movement axis A1. The second drive device 12 is provided for generating a rotational movement of the carrying structure 7, possibly in addition to a powder module 3 arranged therein, around a second movement axis A2, i.e. especially around a vertical rotational axis. From FIG. 2 it can be seen that a rotation of the carrying structure 7 around the second movement axis A2 similarly causes a rotation of the first movement axis A1. Consequently, by rotating the carrying structure 7, the first movement axis A1 can be brought into a certain orientation, especially relative to a first movement axis A1 of a further transport unit 5 arranged directly adjacent the respective transport unit 5.

Overall, the carrying device 2 or a respective transport unit 5 associated with it enables movement of a powder module 3 in two different freedom degrees of motion. A first freedom degree of motion is given by the movement of a powder module 3 relative to the carrying structure 7 along the first movement axis A1 that can be realized by means of the first drive device 10; a second freedom degree of motion is given by the rotational movement of a carrying structure 7 in addition to a powder module 3 arranged therein around the second movement axis A2 that can be realized by means of the second drive device 12.

The first drive device 10 comprises a drive unit 11 and can comprise a power transmission unit 13 coupled with that. The first drive unit 10 is provided for generating of the first drive force setting in motion a powder module 3 along a first movement axis A1. The first drive unit 11 is formed as a linear drive. A respective linear drive can be formed as a hydraulic or pneumatic drive cylinder, threaded drive, especially a ball screw drive or roller screw drive, or a spindle drive.

The power transmission unit 13 is provided for transmitting the first drive force generated by the drive unit 11 to the powder module 3. The power transmission unit 13 comprises at least one power transmission element 14 coupled with the first drive unit 11. The power transmission element 14 is coupled with the first drive unit 11 such that it can be moved along the first movement axis A1 in generating the first drive force setting in motion a powder module 3 along the first movement axis A1.

The power transmission element 14 is movably supported between an operating position, in which it can be coupled or is coupled with a powder module 3 for transmitting the first drive force to the powder module 3, and a non-operating position, in which it cannot be coupled or is not coupled with a powder module 3 for transmitting the first drive force to the powder module 3. The operating position shown in FIG. 1 corresponds to a position of the power transmission element 14 extended from a housing 15 receiving the power transmission element 14; the non-operating position corresponds to a position of the power transmission element 14 retracted into the housing 15 receiving the power transmission element 14. The movement of the power transmission element 14 between the operating and the non-operating position is carried out via a drive unit (not shown in detail) associated with the power transmission unit 13 and arranged or formed in the housing 15, which is provided for generating a linear movement of the power transmission element 14 into the operating position or into the non-operating position. The drive unit is formed as a linear drive analogous to the drive unit 11.

The power transmission element 14 is in the exemplary embodiment according to FIG. 1 formed as a projection-like form-locked element. In the operating position (extended position), the form-locked element can be coupled or is coupled in a form-locked manner with a powder module 3 for transmitting the first drive force to the powder module 3 by the form-locked element interacting with an opposite form-locked element on the powder module 3 in a form-locked manner, i.e., as shown in FIG. 1, engaging in a corresponding reception-like opposite form-locked element (not denoted in more detail) on the powder module 3. In the non-operating position (retracted position), the form-locked element cannot be coupled or is not coupled in a form-locked manner with the powder module 3 for transmitting the first drive force to the powder module 3 by the form-locked element not interacting with an opposite form-locked element on the powder module in a form-locked manner, i.e., for example, not engaging in a corresponding reception-like opposite form-locked element on the powder module 3.

The second drive device 12 comprises several second drive units 16. A first drive unit 16 seen in FIG. 1 is provided for generating a drive force setting the carrying structure 7 in a rotary motion in a first rotational direction, e.g. clockwise, around the second movement axis A2; another second drive unit 16 arranged behind the first drive unit 16 and therefore not seen in FIG. 1 is provided for generating a second drive force setting the carrying structure 7 in rotary motion in a second rotational direction, e.g counter-clockwise, around the second movement axis A2. A respective drive unit 16 is formed as a linear drive. The linear drive is in the exemplary embodiment exemplarily formed as a hydraulic or pneumatic drive cylinder.

The second drive device 12 comprises respective power transmission units 17 coupled with a respective drive unit 16, which are provided for transmitting the drive force generated by a drive unit 16 to the carrying structure 7. The power transmission units 17 comprise a power transmission element 18 coupled with the carrying structure 7, i.e., a thrust or tensile element, e.g. in the form of a cable pull, which is provided for transmitting thrust or tensile forces. A respective power transmission element 18 is eccentrically attached to the carrying structure 7 via an attachment point 19 assigned to the carrying structure 7.

Basically, it would also be conceivable that the drive unit 16 is formed as a rotary drive. The rotary drive can form the second movement axis A2 or can be (directly) integrated in the second movement axis A2. The rotary drive can e.g. be integrated in a storage device 20 storing the carrying structure 7 on the working station 4, 4a-4c.

The transport device 2 can, as mentioned, be provided for transporting powder modules 3, 3a-3c within a working station 4, 4a-4c. From FIG. 2 it can be seen that a working station 4, 4a-4c, here exemplary a first working station 4a, comprises an elongated transport track 20 extending through the working station 4a and forming part of a transport axis T of the system 1, and powder module-specific powder module working positions 22a-22c communicating with that transport track. The transport track 20 is formed by several transport units 5 arranged connected in series. In contrast, a powder module working position 22a-22c is formed by only one (single) transport unit 5.

A powder module-specific powder module working position 22a-22c is a position of a powder module 3, 3a-3c, in which a respective powder module 3, 3a-3c is arranged in the respective working station 4, 4a-4c for an operation in intended use thereof. A first powder module working position 22a is provided for a construction module, a second powder module working position 22b is provided for a metering module 3b, and a third powder module working position 22c is provided for a collector module 22c. The powder module working positions 22a-22c extend along the transport track 20 or are arranged parallel to that.

The transport device 2 is provided for moving or transporting powder modules 3, 3a-3c along the transport track 20 extending through the working station 4a and for moving or transporting powder modules 3, 3a-3c from the transport track 20 into the respective powder module working station 22a-22c and for transporting powder modules 3, 3a-3c from a respective powder module working position 22a-22c into the transport track 20.

Since the powder module working positions 22a-22c are arranged (rect)angularly relative to the transport track 20, for the purpose of transportation or movement of a powder module 3, 3a-3c from a powder module working position 22a-22c into the transport track 20 or vice versa, a rotation of the powder module 3, 3a-3c around the second movement axis A2 and a movement of the powder module 3, 3a-3c along the first movement axis A1 are necessary.

For transferring a powder module 3, 3a-3c e.g. from a transport unit 5 of a powder module working position 22a-22c to one other transport unit 5 of the transport track 20 arranged directly adjacent to that, an equal orientation of the first few movement axes A1 of the transport units 5 is required. Transferring a powder module 3, 3a-3c from a transport unit 5 of a powder module working position 22a-22c to one other transport unit 5 of the transport track 20 arranged directly adjacent to that is thus connected with a movement of the powder module 3, 3a-3c along the respective first movement axis A1. Depending on the spatial orientation of the respective first movement axes A1 of the transport units 5 relative to each other, for transferring a powder module 3, 3a-3c from a transport unit 5 of a powder module working position 22a-22c to one other transport unit of the transport track 20 arranged directly adjacent to that, a rotation of the carrying structure 7 around the second movement axis A2 can (additionally) be required. The rotation of the carrying structure 7 serves for equally orientating the respective first movement axes A1 of the transport units. A rotational position, in which the carrying structure of a transport unit of a powder module working position 22a-22c is oriented such that the first movement axis A1 of that transport unit 5 equals the first movement axis A1 of another transport unit of the transport track 20 arranged directly adjacent to that, can be referred to as transfer position of the transport unit. The distance of the transport units 5 is, of course, in all cases selected so (small) that a transfer of a powder module 3, 3a-3c is possible without any difficulty.

In FIG. 2, for a transfer of the construction module 3a arranged in the powder module working position 22a into the transport track 20, the middle transport unit 5 of the transport track 20 is to be rotated around the second movement axis A2 by 90° in order to achieve a respective transfer position.

The transport device 2 can also be provided for transporting powder modules 3, 3a-3c between at least two working stations 4, 4a-4c.

In FIG. 3, an exemplary embodiment with several working stations 4, 4a-4c arranged directly adjacent is shown. The working stations 4, 4a-4c each comprise a transport track 20 extending through the working stations. The transport track 20 of the working stations 4, 4a-4c are arranged or formed aligned with each other and blend into each other such that a powder module 3, 3a-3c can be moved or transferred from the transport track 20 of a first working station 4, 4a-4c to the transport track 20 of another working station 4, 4a-4c. The transport device 2 is provided for transporting a powder module 3, 3a-3c along the transport track 20 extending through the respective working station 4, 4a-4c and/or for transporting a powder module 3, 3a-3c from the transport track 20 of a working station 4, 4a-4c into a powder module working position 22a-22c of the working station 4, 4a-4c and/or for transporting a powder module 3, 3a-3c from a powder module working position 22a-22c of a working station 4, 4a-4c into the transport track 20 of the working station 4, 4a-4c.

In FIG. 4, an exemplary embodiment with working stations 4, 4a-4c arranged spatially spaced apart is shown. The working stations 4, 4a-4c each in turn comprise a transport track 20 extending through the working stations. The working stations 4, 4a-4c are connected with each other via a tunnel structure 21 extending through them. Evidently, transport tracks 20 also extend through the tunnel structure 21. The transport tracks 20 of the working stations 4, 4a-4c and the transport track 20 of the tunnel structure 21 are each arranged or formed aligned with each other and blend into each other such that powder modules 3, 3a-3c can be moved or transferred from the transport track 20 of a working station 4, 4a-4c to the transport track 20 of the tunnel structure 21, or vice versa. The transport device 2 is also provided for transporting powder modules 3, 3a-3c between working stations 4, 4a-4c and the tunnel structure 21.

In order to be able to be connected with the tunnel structure 21, single, several, or all stationary working stations 4, 4a-4c can have a connection or transfer portion (not shown), via which they are connected with the tunnel structure 21. Thus, a powder module 3, 3a-3c is in transferring from a working station 4, 4a-4c into the tunnel structure 21, or vice versa, to be moved through a respective connecting portion.

The tunnel structure 21 has several inertable tunnel sections 23, in which at least one powder module 3, 3a-3c can be moved. A respective tunnel section 23 limits a cavity, in which respective transport units 5 for transporting powder modules 3, 3a-3c are arranged. In a respective tunnel section 23, transport units 5 are arranged and thus a transport track 20 is defined along which a powder module 3, 3a-3c can be moved through the tunnel section 23. The transport tracks 20 formed in respective working stations 4, 4a-4c can also be considered tunnel sections.

The function of the tunnel structure 21 or the tunnel sections 23 associated with it is to connect at least two different working stations 4, 4a-4c of the system 1 with each other. The connection of respective working stations 4, 4a-4c enables moving respective powder modules 3, 3a-3c between different working stations 4, 4a-4c of the system. A process station 4a can e.g. be connected with a post-processing station 4b via one or more tunnel sections 23.

The control of all movements of the powder modules 3, 3a-3c moved in the system 1, especially in the tunnel structure 21, is carried out via a central control device (not shown), which in a radio-based manner communicates directly or indirectly with respective powder modules 3, 3a-3c, which for this purpose are equipped with suitable communication devices (not shown). In the control device, all information relevant for the movement of respective powder modules 3, 3a-3c within the system 1 or the tunnel structure 21, i.e. especially movement information, i.e., for example, speed information, position information, i.e., for example, start and finish information, prioritization information, etc. are purposefully provided. The movements of the powder modules 3, 3a-3c moved in the system 1 or in the tunnel structure 21 can controlled in a fully automated way.

In FIG. 4 it is exemplarily shown that a respective tunnel section 23 can open out in at least one other tunnel section 23, e.g. extended angled to the respective tunnel section.

1. A system (1) for additive manufacturing of three-dimensional objects, comprising one or more working stations (4, 4a-4c) provided for performing at least one working process in additive manufacturing of three-dimensional objects, and a transport device (2) provided for transporting powder modules (3, 3a-3c) used in additive manufacturing of three-dimensional objects within a working station (4, 4a-4c) and/or between several working stations (4, 4a-4c), characterized in that
the transport device (2) comprises several transport units (5), wherein a respective transport unit (5) comprises
a carrying device (8) comprising a carrying structure (7), which is provided for carrying at least one powder module (3, 3a-3c) arranged in the carrying structure (7),
a first drive device (10) provided for generating a movement of a powder module (3, 3a-3c) arranged in the carrying structure (7) of the carrying device (8) relative to the carrying structure (7) along an, especially linear, first movement axis (A1), and
a second drive device (12) provided for generating a rotational movement of the carrying structure (7) together with a powder module (3, 3a-3c) possibly arranged therein around a second movement axis (A2).

2. The system according to claim 1, characterized in that the first drive device (10) comprises at least one first drive unit (11) especially formed as or comprising a linear drive, which is provided for generating a first drive force setting a powder module (3, 3a-3c) in motion along the first movement axis (A1), and a power transmission unit (13) coupled with the first drive unit (11), which is provided for transmitting the first drive force generated by the first drive device (11) to the powder module (3, 3a-3c).

3. The system according to claim 2, characterized in that the power transmission unit (13) comprises at least one power transmission element (14) coupled with the first drive unit (11), wherein the power transmission element (14) is coupled with the first drive unit (11) such that in generating a first drive force setting a powder module (3, 3a-3c) in motion along the first movement axis (A1), it can be moved along the first movement axis (A1).

4. The system according to claim 3, characterized in that the power transmission element (14) is movably supported between an operating position, in which the power transmission element (14) can be coupled or is coupled with a powder module (3, 3a-3c) for transmitting the first drive force to the powder module (3, 3a-3c), and a non-operating position, in which the power transmission element (14) cannot be coupled or is not coupled with a powder module (3, 3a-3c) for transmitting the first drive force to the powder module (3, 3a-3c).

5. The system according to claim 4, characterized in that the power transmission element (14) is formed as an, especially projection-like, form-locked element, wherein the form-locked element in the operating position can be coupled or is coupled with a powder module (3, 3a-3c) for transmitting the first drive force to the powder module (3, 3a-3c) by the form-locked element interacting with an opposite form-locked element on the powder module (3, 3a-3c), and the form-locked element in the non-operating position cannot be coupled or is not coupled with the powder module (3, 3a-3c) for transmitting the first drive force to the powder module (3, 3a-3c) by the form-locked element interacting with the opposite form-locked element to the powder module (3, 3a-3c) in a form-locking manner.

6. The system according to claim 1, characterized in that the second drive device (12) comprises at least one second drive unit (16), especially formed as or comprising a linear drive or a rotary drive, provided for generating a second drive force setting the carrying structure (7) in a rotary motion around the second movement axis (A2).

7. The system according to claim 6, characterized in that the second drive device (12) comprises a power transmission unit (17) coupled with the second drive unit (16), provided for transmitting the second drive force generated by the second drive unit (16) to the carrying structure (7).

8. The system according to claim 6, characterized in that the power transmission unit (17) comprises a power transmission element (18), especially a thrust or tensile element, coupled with the carrying structure (7), and provided for transmitting thrust or tensile forces.

9. The system according to claim 1, characterized in that the second drive device (12) is formed as or comprises a rotary drive especially integrated into the second movement axis (A2).

10. The system according to claim 1, characterized in that the transport device (2) is provided for transporting powder modules (3, 3a-3c) used in the additive manufacturing of three-dimensional objects within a working station (4, 4a-4c), wherein a working station (4, 4a-4c) comprises a transport track (20) extending through the working station (4, 4a-4c) and at least one powder module-specific powder module working position (22, 22a-22c), wherein the transport device (2) is provided for transporting a powder module (3, 3a-3c) along the transport track (20) extending through the working station (4, 4a-4c) and/or for transporting a powder module (3, 3a-3c) from the transport track (20) into the at least one powder module working position (22, 22a-22c) and/or for transporting a powder module (3, 3a-3c) from the at least one powder module working position (22, 22a-22c) into the transport track (20).

11. The system according to claim 10, characterized in that the at least one powder module working position (22, 22a-22c) is arranged or formed angularly to the transport track (20).

12. The system according to claim 1, characterized in that the transport device (2) is provided for transporting powder modules (3, 3a-3c) used in the additive manufacturing of three-dimensional objects between at least two working stations (4, 4a-4c) that are arranged spatially directly adjacent, wherein a first working station (4, 4a-4c) comprises a transport track (20) extending through the first working station (4, 4a-4c), and another working station (4, 4a-4c) arranged directly adjacent comprises a transport track (20) extending through the other working station (4, 4a-4c), wherein the transport track (20) of the first working station (4, 4a-4c) and the transport track (20) of the other working stations (4, 4a-4c) are arranged or formed aligned with each other such that a powder module (3, 3a-3c) can be transferred from the transport track (20) of the first working station (4, 4a-4c) to the transport track (20) of the other working station (4, 4a-4c), or vice versa.

13. The system according to claim 1, characterized in that the transport device (2) is provided for transporting powder modules (3, 3a-3c) used in the additive manufacturing of three-dimensional objects between at least two working stations (4, 4a-4c) that are arranged spatially adjacent, wherein a first working station (4, 4a-4c) comprises a transport track (20) extending through the first working station (4, 4a-4c), and another working station (4, 4a-4c) arranged directly adjacent comprises a transport track (20) extending through the other working station (4, 4a-4c), and a tunnel structure (21) extending between the first working station (4, 4a-4c) and the at least one other working station (4, 4a-4c) comprises at least one transport track (20) extending through the tunnel structure (21), wherein
the transport track (20) of the first working station (4, 4a-4c) and the transport track (20) of the tunnel structure (21) as well as the transport track (20) of the other working station (4, 4a-4c) and the transport track (20) of the tunnel structure (21) are each arranged or formed aligned with each other such that a powder module (3, 3a-3c) of the transport track (20) of the first working station (4, 4a-4c) can be transferred to the transport track (20) of the tunnel structure (21), or vice versa, and a powder module (3, 3a-3c) can be transferred from the transport track (20) of the other working station (4, 4a-4c) to the transport track (20) of the tunnel structure (21), or vice versa.

14. The system according to claim 10, characterized in that the respective transport tracks (20) are formed by at least one transport unit (5), especially at least two transport units (5) arranged or formed connected in series.

15. The system according to claim 1, characterized in that a first working station (4, 4a-4c) comprises an apparatus for additive manufacturing of three-dimensional objects, and another working station (4, 4a-4c) comprises an apparatus for unpacking an object additively manufactured or an apparatus for cleaning and/or inerting powder modules (3, 3a-3c).
